(19) United States
(12) Patent Application Publication
(10) Pub. No.: US 2010/0217619 A1
(43) Pub. Date: Aug. 26, 2010

(54) METHODS FOR VIRTUAL WORLD MEDICAL SYMPTOM IDENTIFICATION

(76) Inventors: Aaron Roger Cox, Tucson, AZ (US); Luis Ernesto Elizalde Rodarte, Raleigh, NC (US); William J. Grady, IV, Cary, NC (US)

Correspondence Address: ZILKA-KOTAB, PC- IBM, P.O. BOX 721120, SAN JOSE, CA, 95172-1120, US

(21) Appl. No.: 12/393,878

(22) Filed: Feb. 26, 2009

(51) Int. Cl. G06F 3/048; G06Q 50/00

(52) U.S. Cl. 705/2; 715/757

(57) ABSTRACT

In one embodiment, a method includes providing a virtual world accessible by a patient and a medical professional. The virtual world comprises an avatar representing the patient desiring diagnosis. The method also includes receiving indication from the patient of at least one of a medical symptom and a medical condition and outputting a visual indication of the at least one of a medical symptom and a medical condition on the avatar representing the patient.

### BACKGROUND

The present invention relates to virtual worlds, and more particularly, this invention relates to providing an avatar which demonstrates medical symptoms and conditions for diagnosis.

The current medical system is modernizing in order to deal with rising costs and the need for increased flexibility in how patients are serviced. Providing remote medical information and care is a growing trend as seen in the popularity of online tools such as WebMD. Despite the success of web-based medical care, current systems such as live chat with a remote medical professional are limited in that they lack the presence of a human body to aid in the articulation of symptoms and/or conditions. Also, the human body may be useful for feedback and/or advice to the patient. For example, without a medical background, patients may not be able to adequately describe to a doctor where they are feeling symptoms and/or conditions and other significant details such as the degree of discomfort.

Most solutions offered on the two dimensional internet are only conversational in nature. Whether text or voice based, these interactions with a remote health care professional lack the most powerful vehicle for explaining: the physical human body. Therefore, it would be beneficial for remote medical diagnosis to include a form of the human body for helping in the conversation.

### SUMMARY

In one embodiment, a method includes providing a virtual world accessible by a patient and a medical professional. The virtual world comprises an avatar representing the patient desiring diagnosis. The method also includes receiving indication from the patient of at least one of a medical symptom and a medical condition and outputting a visual indication of the at least one of a medical symptom and a medical condition on the avatar representing the patient.

A computer program product for virtual world medical diagnosis, according to another embodiment, includes a computer usable medium having computer usable program code embodied therewith. The computer usable program code is configured to provide a virtual world accessible by a patient and a medical professional. The virtual world comprises an avatar representing the patient desiring diagnosis. Also, the computer usable program code is configured to receive indication from the patient of at least one of a medical symptom and a medical condition and to output a visual indication of the at least one of a medical symptom and a medical condition on the avatar representing the patient.

In another embodiment, a system for virtual world medical diagnosis includes a computer readable medium and a device for outputting information to a user. The system also includes a device for inputting information from a user and a processor for executing computer usable code. The computer usable program code is stored on the computer readable medium, and the computer usable code is configured to cause the processor to provide a virtual world accessible by a patient. The virtual world comprises an avatar representing the patient desiring diagnosis. The computer usable program code stored on the computer readable medium is also configured to cause the processor to receive indication from the patient of at least one of a medical symptom and a medical condition and to cause the processor to output a visual indication of the at least one of a medical symptom and a medical condition on the avatar representing the patient.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a flow chart of a method for virtual world medical diagnosis according to one embodiment.

FIGS. 4A-4E show an illustrative virtual world including a patient and a medical professional according to one embodiment.

### DETAILED DESCRIPTION

The following description is made for the purpose of illustrating the general principles of the present invention and is not meant to limit the inventive concepts claimed herein. Further, particular features described herein may be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of systems, methods and computer program products for virtual world medical diagnosis.

In one general embodiment, a method includes providing a virtual world accessible by a patient and a medical professional, comprising an avatar representing the patient desiring diagnosis; receiving indication from the patient of at least one of a medical symptom and a medical condition; and outputting a visual indication of the at least one of a medical symptom and a medical condition on the avatar representing the patient.

In another general embodiment, a computer program product for virtual world medical diagnosis includes a computer usable medium having computer usable program code embodied therewith, the computer usable program code comprising computer usable program code configured to provide a virtual world accessible by a patient and a medical professional, comprising an avatar representing the patient desiring diagnosis; computer usable program code configured to receive indication from the patient of at least one of a medical symptom and a medical condition; and computer usable program code configured to output a visual indication of the at least one of a medical symptom and a medical condition on the avatar representing the patient.

In another general embodiment, a system for virtual world medical diagnosis includes a computer readable medium; a device for outputting information to a user; a device for inputting information from a user; a processor for executing computer usable code; computer usable program code stored on the computer readable medium, the computer usable code configured to cause the processor to provide a virtual world accessible by a patient, the virtual world comprising an avatar representing the patient desiring diagnosis; computer usable program code stored on the computer readable medium, the computer usable code configured to cause the processor to receive indication from the patient of at least one of a medical symptom and a medical condition; and computer usable program code stored on the computer readable medium, the computer usable code configured to cause the processor to output a visual indication of the at least one of a medical symptom and a medical condition on the avatar representing the patient.

As will be appreciated by one skilled in the art, the present invention may be embodied as a system, method or computer program product. Accordingly, the present invention may take the form of an entirely hardware embodiment, a software embodiment (including firmware, resident software, micro-code, etc.) operating an apparatus or an embodiment combining software and hardware aspects that may all generally be referred to herein as a “circuit,” “module” or “system.” Furthermore, the present invention may take the form of a computer program product stored in any tangible medium of expression having computer-usable program code stored in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that may direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

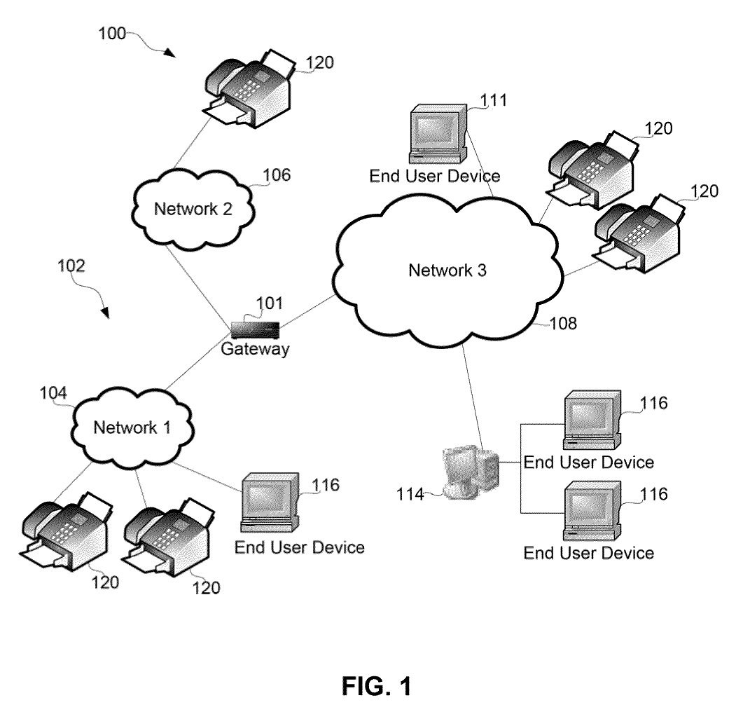

FIG. 1 illustrates a network architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, PSTN, internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked storage units, etc. may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

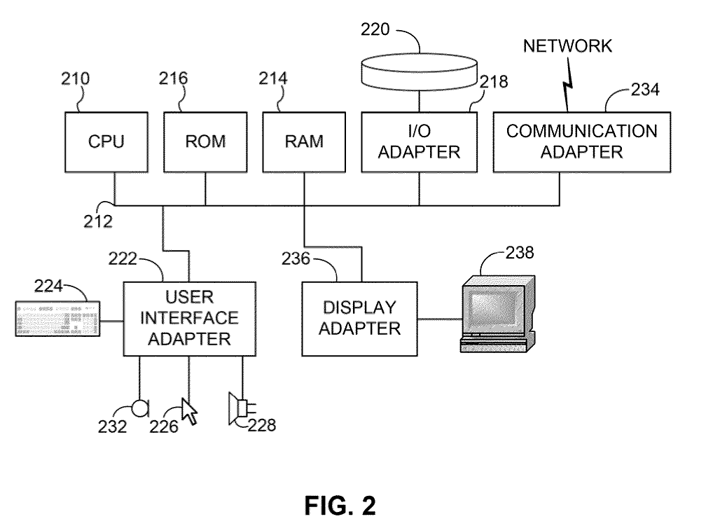

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, or UNIX operating system. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

According to some embodiments, a virtual world may include an avatar representing a patient, e.g., a patient's body or portions thereof, and having user interface selection menus and motion tools that would allow more descriptive communication with remote medical professionals. One advantage of this type of remote diagnosis includes giving the remote medical professional a greater amount of data and higher level of accuracy than previously available with existing remote communication options.

In one embodiment, a method may also facilitate the collection and storage of remote patient data, including the resulting patient/doctor communications. Also, the virtual presence of the doctor's avatar, e.g., representing the doctor's body or portions thereof, may add a level of real world interaction that patients have come to expect in the treatment and diagnosis of medical conditions and ailments. The visual richness of Virtual Worlds makes this interaction more natural and seamless.

Currently, visitors (patients) to doctors' offices and emergency rooms often have to wait for a long time to be admitted. Patients usually speak to a nurse before they meet with the doctor, but this process may be streamlined by virtualizing admission and the nurses' roles to some degree. Congestion in the doctors' offices and emergency rooms may be alleviated by providing access to a pool of remote nurses. In one approach, the patient may go through the admission and pre-examination steps from home or in an exam room with a virtual nurse. This data may then be provided to the doctor in a normal fashion. In some embodiments, this method may also help to bring health care to those who cannot get access to personal medical expertise, such as remote villages in third world countries, remote areas like research facilities in Antarctica, astronauts in space, etc. In these embodiments, the doctor who cannot be there in person may be there virtually to treat the patient.

In many embodiments, the virtual world medical diagnosis may provide several novel tools for more descriptive communication with remote medical professionals.

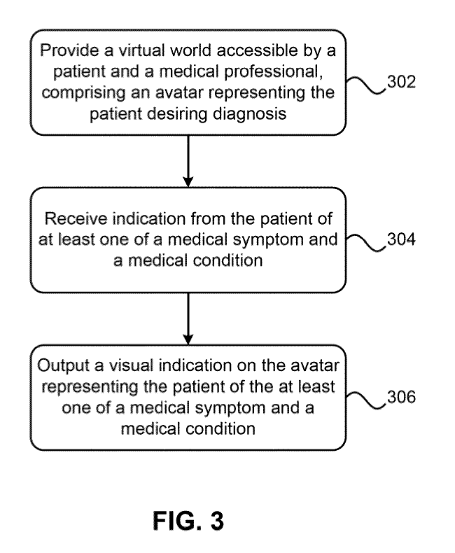

Now referring to FIG. 3, a method 300 is shown according to some embodiments. The method 300 may be used in any desired environment, including those shown in FIGS. 1 and 2.

In operation 302, a virtual world accessible by a patient and a medical professional is provided, wherein the virtual world comprises an avatar representing the patient desiring diagnosis. This avatar may be designed to look similar to the patient, e.g., have the same sex, have the same color hair and eyes, have similar facial hair, have a similar build, etc. In addition, in some embodiments, the avatar may have indications of past injuries and/or surgeries that are readily apparent. In additional embodiments, the avatar may or may not be stationary, e.g., does not move on the screen other than to manipulate the view so that other portions of the avatar's body may be seen.

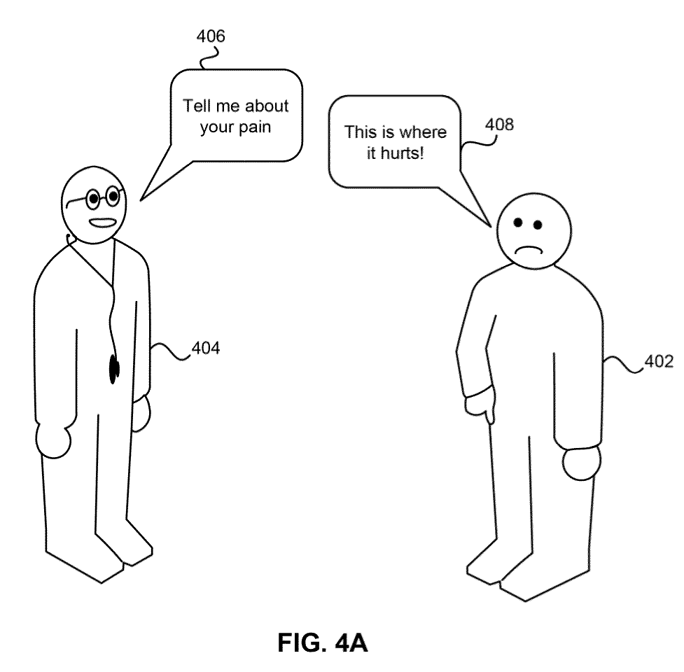

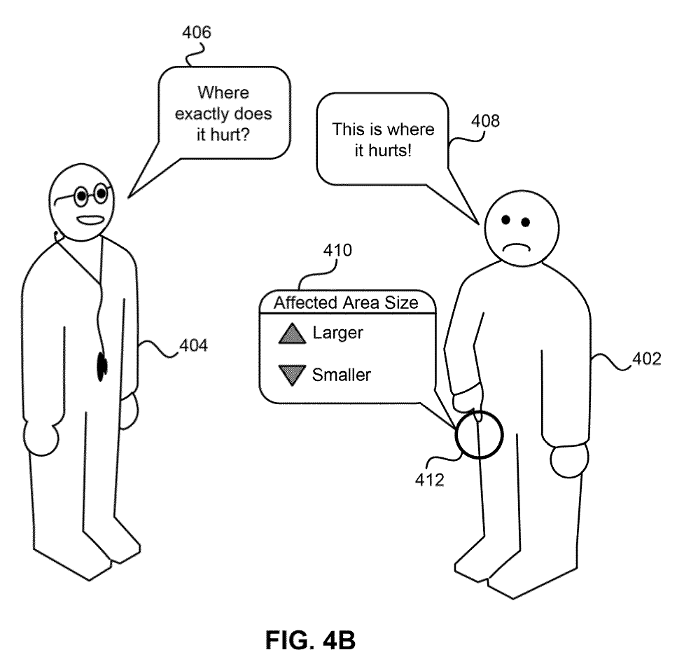

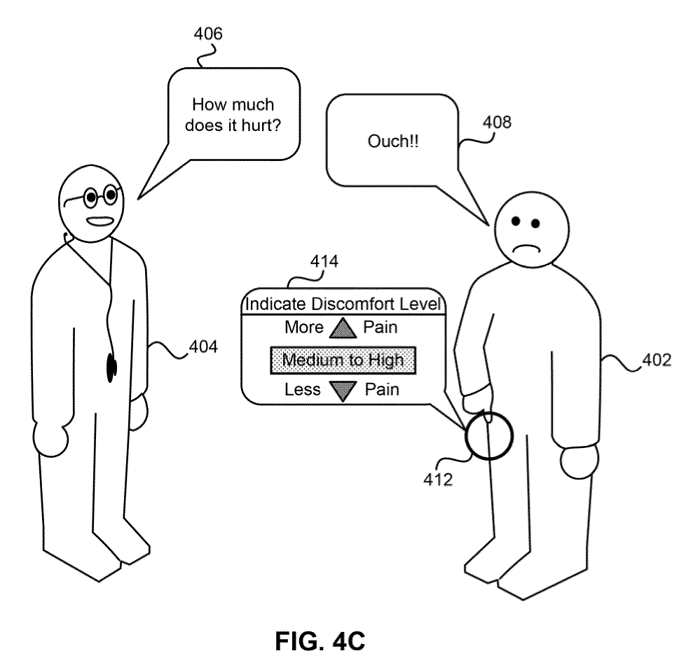

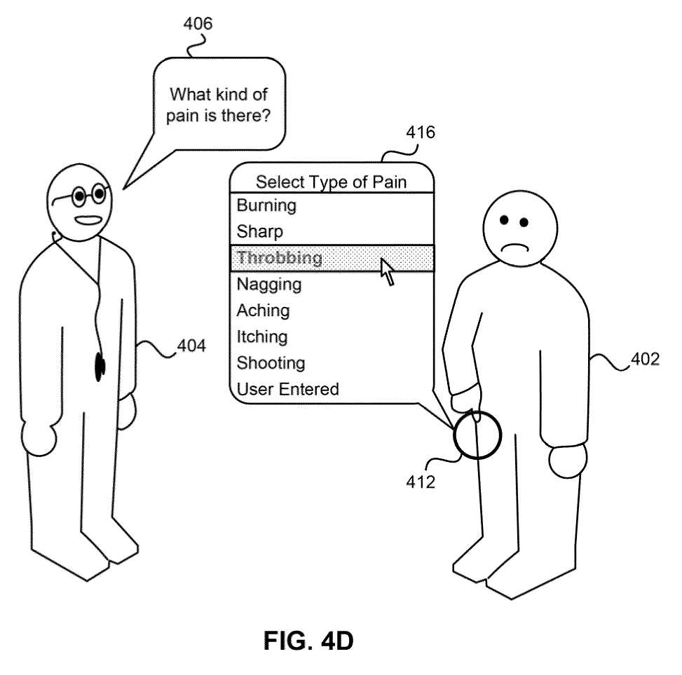

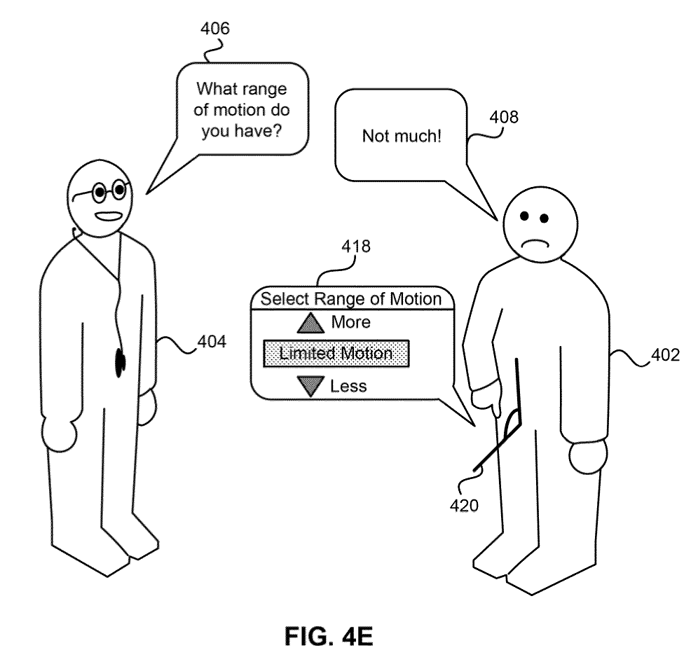

Of course, in some embodiments, a patient and a medical professional may be allowed access to an existing virtual world, wherein the virtual world comprises an avatar representing the patient desiring diagnosis. For example, in FIG. 4A, a virtual world is shown including a patient avatar 402 and a medical professional avatar 404.

In operation 304, indication is received from the patient of at least one of a medical symptom and a medical condition. For example, a medical symptom might be sniffles, sneezing, achy head, cough, joint pain, etc. A medical condition might be something that a patient has had past experiences with, or something readily appreciable, such as a broken arm. Some symptoms/conditions may fall into both of these categories, such as a fever. For example, as shown in FIG. 4A, the patient has indicated where on the body of the patient avatar 402 the patient has pain.

The indication that is received from the patient, according to some embodiments, may be input by the patient through a user interface for indication on the avatar of a medical symptom and/or a medical condition. The user interface may include graphics, logos, words, descriptions, interactive features, etc. Any type of user interface device known in the art may be used. For example, in FIG. 4A, the medical professional avatar has a dialog box 406 for indication of questions, diagnosis, etc. Also, the patient avatar 402 has a dialog box for indication to the medical professional of symptoms, pains, conditions, etc.

In operation 306, a visual indication is output of the at least one of a medical symptom and a medical condition on the avatar representing the patient. For example, a visual indication may include a different color from the rest of the avatar indicating an injury, a throbbing surface of the avatar, a circle around a portion of the avatar representing an affected area, etc. More examples of visual indications are provided below and described in greater detail. In FIG. 4B, a darker circle 412 indicates an area of pain on the patient avatar 402.

In some embodiments, the method 300 may further comprise providing a chat box for textual conversation between the medical professional and the patient. The chat box may also be accessible by other parties, and may be saved for review later on by either the medical professional and/or the patient.

In some more embodiments, the method 300 may further comprise providing a connection between the medical professional and the patient for audible conversation. This connection may be a telephony connection, an internet connection (such as voice-over-internet protocol (VOIP)), an intercom, etc.

In some embodiments, the method 300 may further comprise providing an avatar representing the medical professional, such as shown in FIG. 4A-4E as 404, wherein the avatar representing the medical professional interacts with the avatar representing the patient, such as shown in FIG. 4A-4E as 402. The avatar representing the medical professional may also look similar to the medical professional, e.g., have the same sex, have the same color hair and eyes, have similar facial hair, etc. Also, the interaction between the avatar representing the patient and the avatar representing the medical professional may be dictated by input from the medical professional and/or the patient, may be preset according to certain conditions and/or symptoms, may include predetermined routines that execute based on any factors, etc.

In some further embodiments, the user interface for indication on the avatar may include a selection tool that allows the patient to indicate a size and a location of an area on the avatar that is representative of an affected area on the patient, as shown in FIG. 4B as tool 412. For example, if a patient has a bruise on her left arm, the selection tool may allow the patient to select an area on the left arm of the avatar representing the bruise on the left arm. In another example, if the patient has a general condition, such as a cold which is affecting the head and lungs, the selection tool may allow the patient to select the lungs and/or the head to indicate the affected areas.

In some more embodiments, the user interface for indication on the avatar may further comprise a user interface element to increase or decrease a size of the representation on the avatar of the affected area on the patient, as shown in FIG. 4B as tool 410. This interface element may include choices to select all of the body of the avatar, only certain body parts such as the arm, leg, head, etc., and/or portions of the body specified by the patient. In addition, the interface element may include a pull-down menu, a pop-up menu, a slider, a toggle button, a window, etc.

Also, in some embodiments, the user interface for indication on the avatar may further comprise a user interface element to increase or decrease a level of discomfort the affected area is causing the patient which is indicated visually on the avatar, as shown in FIG. 4C as tool 414. In some embodiments, the level of discomfort may be indicated as a value, such as a value from 1-10, with 10 being the most discomfort, and 1 being the least discomfort. This interface element may include up and down arrow buttons, a slider, etc. The interface element may include a pull-down menu, a pop-up menu, a toggle button, a window, etc. In addition, in some further embodiments, the visual indication of the level of discomfort on the avatar may change from a first color indicating low levels of discomfort to a second color indicating high levels of discomfort. For example, low levels of discomfort may be indicated by green, while high levels of discomfort may be indicated by red.

According to some embodiments, the patient and/or the medical professional may add notations to specific body areas with information such as how the injury happened, how long it has been affected, how severe it is, etc. Comments may be saved (may be text chat), such as advice for each affected area. Voice recordings of comments and recommendations or indications may also be saved. All of this information may be savable data linked to each patient's avatar for future reference.

In some further embodiments, a real world patient may wear a suit, may have a glove, etc., which is connected to a computer for receiving input from where the patient points at her body to indicate the symptom and/or condition that is affecting the patient. Software may be able to translate the input from the patient into a visual representation on the avatar.

In some embodiments, the input device may include a location sensing suit that the patient touches to indicate where it hurts. The suit may be connected to a computer and the computer may translate the input from the patient into a visual representation on the avatar.

In another embodiment, a typical web cam with image recognition software that recognizes real body locations may associate the motions of the patient into visual representations of symptoms and/or conditions on the avatar. In one approach, the real world patient may hold up special colored locator dots to indicate body locations to the web cam. Software may translate the locations onto the avatar's body.

In yet another embodiment, an apparatus may be located in a public location that may receive input from a patient and present it in a virtual world on an avatar representing the patient. This apparatus may be in a hospital waiting room to help expedite the wait and it may substitute or supplement the nurse's work. It may also initiate the discussion even before going to the doctor's office.

In more embodiments, the user interface for indication on the avatar may further comprise a user interface element to select a type of discomfort that is representative of the discomfort being experienced by the patient, as shown in FIG. 4D as tool 416. This type of discomfort may be presented in and selected from a list of pain types, which may include acute, aching, burning, deep, intermittent, itching, lingering, nagging, pressure, pulsating, sharp, and/or throbbing. Other types of discomfort may be included as well as would be known to one of skill in the relevant art. In even more embodiments, the patient and/or the medical professional may enter a type of discomfort that does not appear in the list. Also, the user interface element to select a type of discomfort may further comprise a time frequency selection for a pulsating or intermittent discomfort type which allows the patient to select how often the discomfort occurs and is displayed on the avatar. For example, if the pain only occurs in the morning, the patient may select a time frequency which indicates that the pain is only present in the morning.

In some more embodiments, the user interface for indication on the avatar may further comprise a range of motion tool to increase or decrease a range of motion for a selected part of the body of the avatar that is representative of the range of motion of a part of the patient's body, as shown in FIG. 4E as tool 418. This tool may be particularly useful for athletes or people with mobility problems. For example, the range of motion tool may include a circle, with two markers for indication of the extent of motion that the patient is able to perform with the affected body part, such as an arm, leg, neck, etc., as shown in FIG. 4E as tool 420 In some further embodiments, the range of motion tool may further comprise a selectable normal range of motion for a selected part of the body of the avatar that is representative of a part of the patient's body. For example, if the patient is normally able to fully rotate his neck, but due to an injury is only able to rotate it to the left, the avatar may be able to indicate the normal range of motion and the current range of motion.

In some approaches, the user interface for indication on the avatar may further comprise a user interface element for selection of a condition from a list. The list may include bleeding, infected, swollen, and/or weeping. Other conditions may be included as well as would be known to one of skill in the relevant art. In addition, in some further approaches, each condition in the list may be indicated on the avatar in a different color when selected. For example, a headache may be indicated in brown, while a fever may be indicated in red.

In more embodiments, the virtual world may further comprise a dialog box capable of accepting and displaying comments from the medical professional. For example, the medical professional may be able to input comments audibly through a microphone and/or telephone receiver, or the medical professional may be able to input comments on a keyboard, selection through a mouse click, etc. Any input method may be used to collect the comments from the medical professional so that the patient may review the comments and instructions in the dialog box.

In more embodiments, the user interface for indication on the avatar may further comprise animations typical of the selected symptom or condition. For example, a broken arm may be shown on the avatar as a stick that is broken in two, a fever may be shown on the avatar as a thermometer which is displaying a high temperature, a rash may be shown as red spots on the skin of the avatar, etc. In some more examples, when selecting the type of pain from a list, the list may show the affected area with a small bright red spot to show sharp pain, and an area with a flame effect to indicate a burning pain.

In some additional embodiments, the user interface for indication on the avatar may further comprise a selectable duration indicative of how long the symptom or condition has been affecting the patient. For example, the patient may be able to select a duration ranging from less than about one hour to more than about six months, one year, etc. Any time periods may be used, such as minutes, hours, days, weeks, etc.

Another possibility to convey the patient's medical condition and/or symptom is to use a live video camera to show the patient in real time to the medical professional. However, for some patients, this would be too intimidating for a patient to show his body live on camera to another person. Also, it might be difficult, for example, for a patient to point to a sore spot on his back when doing so might result in further discomfort. Therefore, a virtual world representation is a better method of remote medical diagnosis than using a live camera in many situations.

In some embodiments, the method described above may be embodied in a computer program product for virtual world medical diagnosis. The computer program product may be included and accessible through the internet, and/or other remotely located and accessible server sites.

In another embodiment, the method described above may be embodied in a system for virtual world medical diagnosis. The system may comprise a computer readable medium, a device for outputting information to a user, a device for inputting information from a user, a processor for executing computer usable code, and computer usable program code stored on the computer readable medium, the computer usable code configured to cause the processor to perform the method described above.

The computer readable medium may be any medium, such as CD-ROM, DVD-ROM, flash memory, magnetic tape, etc. The device for inputting information from a user may include a mouse, keyboard, microphone, etc. The device for outputting information to a user may include a monitor, speakers, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
providing a virtual world accessible by a patient and a medical professional, the virtual world comprising an avatar representing the patient desiring diagnosis;
receiving indication from the patient of at least one of a medical symptom and a medical condition; and
outputting a visual indication of the at least one of a medical symptom and a medical condition on the avatar representing the patient.

2. A method as recited in claim 1, further comprising providing a chat box for textual conversation between the medical professional and the patient.

3. A method as recited in claim 1, further comprising providing a connection between the medical professional and the patient for audible conversation.

4. A method as recited in claim 1, further comprising providing an avatar representing the medical professional, wherein the avatar representing the medical professional interacts with the avatar representing the patient.

5. A method as recited in claim 1, further comprising a user interface for indication of the at least one of a medical symptom and a medical condition on the avatar representing the patient.

6. A method as recited in claim 5, wherein the user interface for indication on the avatar comprises a selection tool that allows the patient to indicate a size and a location of an area on the avatar that is representative of an affected area on the patient.

7. A method as recited in claim 5, wherein the user interface for indication on the avatar further comprises a user interface element to increase or decrease a size of the representation on the avatar of the affected area on the patient.

8. A method as recited in claim 5, wherein the user interface for indication on the avatar further comprises a user interface element to increase or decrease a level of discomfort the affected area is causing the patient which is indicated visually on the avatar.

9. A method as recited in claim 8, wherein the visual indication of the level of discomfort on the avatar changes from a first color indicating low levels of discomfort to a second color indicating high levels of discomfort.

10. A method as recited in claim 5, wherein the user interface for indication on the avatar further comprises a user interface element to select a type of discomfort that is representative of a type of discomfort being experienced by the patient from a list of pain types, wherein the list includes at least one of acute, aching, burning, deep, intermittent, itching, lingering, nagging, pressure, pulsating, sharp, and throbbing.

11. A method as recited in claim 10, wherein the user interface element to select a type of discomfort further comprises a time frequency selection for a pulsating or intermittent discomfort type which allows the patient to select how often the discomfort occurs and is displayed on the avatar.

12. A method as recited in claim 5, wherein the user interface for indication on the avatar further comprises a range of motion tool to increase or decrease a range of motion for a selected part of the body of the avatar that is representative of the range of motion of a part of the patient's body.

13. A method as recited in claim 12, wherein the range of motion tool further comprises a selectable normal range of motion for a selected part of the body of the avatar that is representative of a part of the patient's body.

14. A method as recited in claim 5, wherein the user interface for indication on the avatar further comprises a user interface element for selection of a condition from a list, wherein the list includes at least one of bleeding, infected, swollen, and weeping.

15. A method as recited in claim 14, wherein each condition in the list is indicated on the avatar in a different color when selected.

16. A method as recited in claim 1, wherein the virtual world further comprises a dialog box capable of accepting and displaying comments from the medical professional.

17. A method as recited in claim 1, wherein the user interface for indication on the avatar further comprises animations typical of the selected symptom or condition.

18. A method as recited in claim 1, wherein the user interface for indication on the avatar further comprises a selectable duration indicative of how long the symptom or condition has been affecting the patient.

19. A computer program product for virtual world medical diagnosis, the computer program product comprising:
a computer usable medium having computer usable program code embodied therewith, the computer usable program code comprising:
computer usable program code configured to provide a virtual world accessible by a patient and a medical professional, comprising an avatar representing the patient desiring diagnosis;
computer usable program code configured to receive indication from the patient of at least one of a medical symptom and a medical condition; and
computer usable program code configured to output a visual indication of the at least one of a medical symptom and a medical condition on the avatar representing the patient.

20. A system for virtual world medical diagnosis, the system comprising:
a computer readable medium;
a device for outputting information to a user;
a device for inputting information from a user;
a processor for executing computer usable code;
computer usable program code stored on the computer readable medium, the computer usable code configured to cause the processor to provide a virtual world accessible by a patient, the virtual world comprising an avatar representing the patient desiring diagnosis;
computer usable program code stored on the computer readable medium, the computer usable code configured to cause the processor to receive indication from the patient of at least one of a medical symptom and a medical condition; and
computer usable program code stored on the computer readable medium, the computer usable code configured to cause the processor to output a visual indication of the at least one of a medical symptom and a medical condition on the avatar representing the patient.
